(19) United States
(12) Patent Application Publication
(10) Pub. No.: US 2020/0063336 A1
(43) Pub. Date: Feb. 27, 2020

(54) DURABLE SUPER-HYDROPHOBIC FABRIC AND PREPARATION METHOD THEREOF

(71) Applicant: SOUTH CHINA UNIVERSITY OF TECHNOLOGY, Guangzhou City (CN)

(72) Inventors: Hongqiang LI, Guangzhou City (CN); Xiaojing SU, Guangzhou City (CN); Xingrong ZENG, Guangzhou City (CN); Xuejun LAI, Guangzhou City (CN); Lin ZHANG, Guangzhou City (CN)

(73) Assignee: SOUTH CHINA UNIVERSITY OF TECHNOLOGY, Guangzhou City (CN)

(21) Appl. No.: 16/466,304

(22) PCT Filed: Nov. 23, 2017
(86) PCT No.: PCT/CN2017/112634

§ 371 Date: Jun. 4, 2019

(30) Foreign Application Priority Data
May 27, 2017 (CN) 201710388112.2

(51) Int. Cl. D06M 15/643; C09D 5/00; C09D 183/06; D06M 13/10

(52) U.S. Cl. CPC D06M 15/643; C09D 5/00; D06M 2200/12; D06M 13/10; C09D 183/06

(57) ABSTRACT

The invention discloses a durable super-hydrophobic fabric and a preparation method thereof. The preparation method comprises the following steps: soaking a fabric into a mixed solution of tetraethoxysilane and hydroxy-terminated polydimethylsiloxane; taking out the fabric and then placing it into a closed container filled with a hydrochloric acid solution and above the liquid level of the hydrochloric acid solution; reacting for 0.5-2 h under the temperature of 30-60 DEG C. to give the durable super-hydrophobic fabric. The fabric prepared according to the invention has a water drop surface static contact angle of more than 150° such that the water drop is easy to roll on the surface of the fabric, and has excellent chemical stability and mechanical durability. In addition, the preparation process is simple and pollution-free.

### FIELD OF THE INVENTION

The invention relates to a super-hydrophobic material, in particular to a durable super-hydrophobic fabric and a preparation method thereof.

### BACKGROUND OF THE INVENTION

Inspired by lotus leaf surface, butterfly wings, animal feathers, and the like in nature, people have designed and invented super-hydrophobic fabrics with a static droplet contact angle greater than 150°, water droplets prone to rolling on the surface of the fabrics. Super-hydrophobic fabrics have important application value in self-cleaning, anti-ice coverage, anti-pollution, flame retardancy, oil-water separation, etc., and have attracted wide attention.

At present, there have been many reports on the preparation methods of super-hydrophobic fabrics, such as chemical etching, sol-gel, vapor deposition, ultraviolet curing, etc., but the following problems still exist: the preparation process is cumbersome, the reaction conditions are harsh, and special expensive instruments are needed, which can only be limited to laboratory research; the fluorine-containing low surface energy material is used to modify the fabric in order to construct a super-hydrophobic surface, but the long-chain fluorine-containing monomer is easily oxidized and decomposed in the natural environment, which may cause serious harm to human health and the ecological environment; the use of toxic solvents such as tetrahydrofuran, toluene and acetone during the preparation process also violates the purpose of “green chemistry”; the micro-nano roughness structure is easily damaged due to the weak adhesion force between the fabric and the low surface energy substance, resulting in poor resistance of the fabric to external damage, easy loss of super-hydrophobicity after wash or wear, and poor durability. Therefore, it is particularly important to develop a super-hydrophobic fabric with a simple preparation method, cost effectiveness, environmental protection and high durability.

### CONTENTS OF THE INVENTION

In view of the prior art problems such as complicated preparation process, harsh reaction conditions and poor durability of super-hydrophobic fabrics, the invention provides a super-hydrophobic fabric with simple preparation process, low cost and environmental friendliness, and a preparation method thereof. The obtained fabric has excellent chemical stability, mechanical durability and long-term super-hydrophobicity.

The invention adopts a one-step gas-liquid sol gel method. First soaking a common fabric into a mixed solution of tetraethoxysilane and hydroxy-terminated polydimethylsiloxane; taking out the fabric and then placing it into a closed container filled with a volatile hydrochloric acid gas; keeping the closed container at a constant temperature for a certain period of time, such that the tetraethoxysilane forms silicon dioxide in situ on the surface of the fabric through hydrolysis and polycondensation; and then having a crosslinking reaction occurred between the silanol groups of the silicon dioxide and the terminal hydroxyl groups of the polydimethylsiloxane, to produce a super-hydrophobic fabric with a micro-nano roughness surface. The invention utilizes hydrolysis and polycondensation of tetraethoxysilane to form silicon dioxide in situ on the fabric under the catalysis of hydrochloric acid gas, and then has a polycondensation reaction occurred between the silanol groups of the silicon dioxide and the terminal hydroxyl groups of polydimethylsiloxane, forming a durable super-hydrophobic fabric having a cross-linked structure and a micro-nano roughness surface. The method of the invention has the advantages of low cost, environmental protection, simple operation and the like; and the prepared super-hydrophobic fabric has excellent chemical stability and mechanical durability, and can maintain super-hydrophobicity for a long time even under severe environments. The following reactions occur during the preparation of the durable super-hydrophobic fabric:

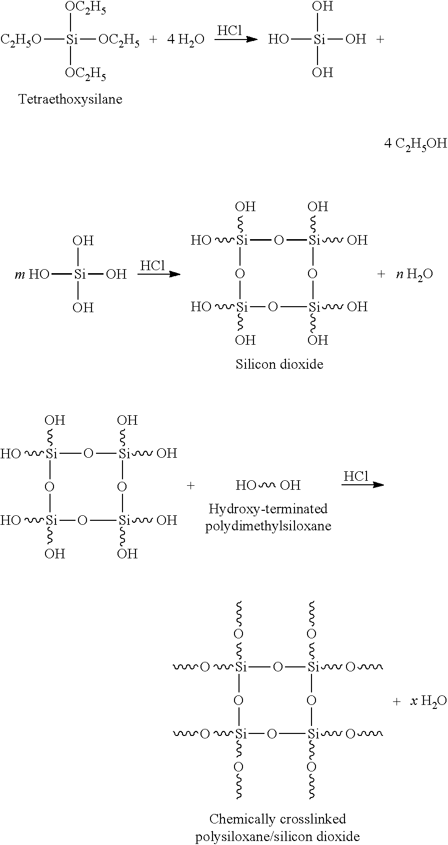

The objects of the invention are achieved by the following technical solution:

A preparation method of a durable super-hydrophobic fabric is provided, comprising the following steps: soaking a fabric into a mixed solution of tetraethoxysilane and hydroxy-terminated polydimethylsiloxane; taking out the fabric and then placing it into a closed container filled with a hydrochloric acid solution and above the liquid level of the hydrochloric acid solution; reacting for 0.5-2 h under the temperature of 30-60 ° C. to obtain the durable super-hydrophobic fabric.

For further achieving the purpose of the invention, the hydroxy-terminated polydimethylsiloxane preferably has a molecular weight of from 400 to 8,000.

Preferably, the mass ratio of the tetraethoxysilane to the hydroxy-terminated polydimethylsiloxane is from 2:1 to 5:1.

Preferably, the mass percentage of the hydrochloric acid solution is 10-20 wt %.

Preferably, the reacting for 0.5-2 h under the temperature of 30-60 ° C. is carried out by placing the closed container in an oven at a controlled temperature of 30-60 ° C.

Preferably, the fabric is a fabric of any one of polyester, cotton, wool, nitrilon, polyurethane, and nylon.

A durable super-hydrophobic fabric is prepared by the above method.

Preferably, the durable super-hydrophobic fabric has a contact angle of from 150° to 165° , and can still remain super-hydrophobic after 168 h or more of organic solvent soaking, and 112 washes (the 2 A conditions of AATCC Test Method 61-2006) or 600 wears for testing.

The preparation method of the durable super-hydrophobic fabric according to the invention has the following advantages compared with the prior art:

(1) The invention prepares the super-hydrophobic fabric by a one-step gas-liquid sol gel method, which has the advantages of simple operation, mild conditions, no need to use fluorine-containing substances or toxic solvents, no need for special equipment, etc., and can be applied to large-scale industrial production.

(2) The silicon dioxide in the super-hydrophobic fabric prepared by the invention is deposited to form a micro-nano roughness structure, and then forms a chemically crosslinked structure with polydimethylsiloxane by dehydration and condensation of hydroxyl groups; therefore, this fabric can maintain high hydrophobicity even after a long-time soak in different solvents, and keep its hydrophobicity substantially constant after repeated washing and wearing, having excellent chemical stability and mechanical durability.

### BRIEF DESCRIPTION OF THE DRAWINGS

FIG. 1 shows a scanning electron micrograph of the wear-resistant super-hydrophobic fabric prepared in Example 1 (the image has a magnification of 1000 times, the illustration in the upper right corner has a magnification of 5000 times, and the illustration in the lower right corner is a water contact angle photograph).

FIG. 2 shows the infrared spectra of a pure fabric obtained in Example 1 and a fabric obtained by being soaked in a mixture of tetraethoxysilane and polydimethylsiloxane and then reacted at 45° C. for different time.

FIG. 3 shows a schematic view of the wear-resistant super-hydrophobic fabric prepared in each example when subjected to wear testing.

### DETAILED DESCRIPTION OF THE EMBODIMENTS

In order to make the invention better understood, the invention will be further described below in conjunction with examples; however, the embodiments of the invention are not limited thereto.

### Example 1

Soaking a polyester fabric into a mixed solution of tetraethoxysilane and polydimethylsiloxane having a molecular weight of 400 at a mass ratio of 3:1; taking out the fabric and then placing it into a closed container filled with a hydrochloric acid solution (mass fraction: 20 wt %) and above the liquid level of the hydrochloric acid solution; placing the closed container in an oven and reacting for 1 h under the temperature of 45° C. to obtain the durable super-hydrophobic fabric.

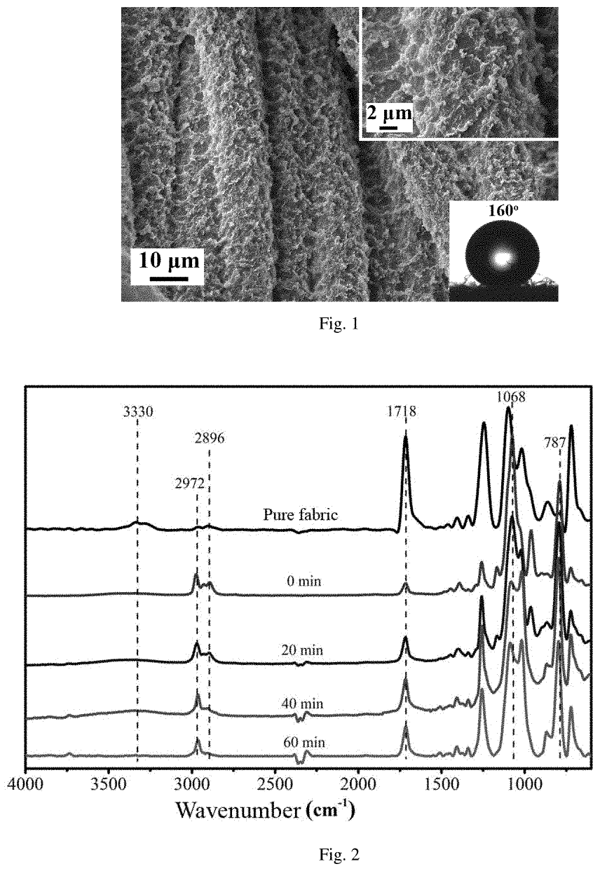

A brief description of how to get FIG. 1 is needed, including magnification. FIG. 1 shows a scanning electron micrograph of a 1000-fold magnification of the durable super-hydrophobic fabric obtained in this example, wherein the illustration in the upper right corner is a scanning electron microscope magnified 5000 times, and the illustration in the lower right corner is a photograph of a water contact angle. As can be seen from FIG. 1, on the surface of the super-hydrophobic fabric, silicon dioxide was deposited to form a micro-nano roughness structure, and water contact angle was 160°, exhibiting super-hydrophobic characteristic.

FIG. 2 shows an infrared spectrum of a pure fabric obtained in this example and a fabric obtained by being soaked in a mixture of tetraethoxysilane and polydimethylsiloxane and then reacted at 45° C. for different time. It can be seen from FIG. 2 that, compared with pure fabric, the fabric after being soaked in the mixture of tetraethoxysilane and polydimethylsiloxane had weakened intensity at a hydroxyl vibration peak at 3330 cm⁻¹ and a carbonyl vibration peak at 1719 cm⁻¹, and enhanced intensity at a CH₃ vibration peak at 2972 cm⁻¹ and a CH₂ vibration peak at 2896 cm⁻¹, and also had new Si—O—Si and Si—C peaks appearing at 1068 cm⁻¹ and 787 cm⁻¹. With the progress of the reaction, the hydroxyl absorption peak at 3200-3400 cm⁻¹ first appeared and then disappeared; the intensity of the CH₃ peak decreased slightly, while the intensity of the CH₂ peak decreased greatly, but both remained unchanged later. Besides, the Si—O—Si peak shifted to a high wavenumber position, and the peak width at 900-1100 cm⁻¹ also gradually increased. This indicates that the tetraethoxysilane underwent a hydrolytic condensation reaction early in the reaction, and the generated silicon dioxide crosslinked with the hydroxy-terminated polydimethylsiloxane later in the reaction.

In order to evaluate the chemical stability of the super-hydrophobic fabrics, they were respectively soaked in a 50 mL beaker containing 30 mL of acetone, ethanol, toluene and hexane, sealed with plastic wrap, soaked at room temperature for 168 h, and washed with ethanol, and then dried in a blast drying oven at 50° C. for 1 h; and the contact angle was measured. Table 1 lists the contact angles of the durable super-hydrophobic fabrics of this example measured after the fabrics had been respectively soaked in acetone, ethanol, toluene and hexane for 168 h and then dried. It can be seen from Table 1 that the water contact angle of the durable super-hydrophobic fabric prepared in this example did not change much after the fabric had been soaked in different solvents for a long time, indicating that the fabric had excellent chemical stability.

In order to evaluate the wash resistance of the super-hydrophobic fabric, the fabric was washed according to the 2 A conditions of AATCC Test Method 61-2006, with the specific method as follows: Adjusting the water color fastness tester (SW-12A, Wenzhou Fangyuan Instrument Co., Ltd.) to a water temperature of 49° C., and adding to a steel cup of 90×200 mm in size 150 mL of deionized water, 0.015 g of detergent, and 50 steel balls of 6 mm in diameter and 1 g in mass. Two minutes after preheating the steel cup, placing a fabric of 50×150 mm in size in the steel cup, and restarting the instrument to operate at 40±2 rpm for 45 min Finally, taking out the sample, washing it three times with ethanol, and drying it in an oven at 60° C. Table 2 lists the contact angles measured after 112 washes of the durable super-hydrophobic fabric of this example in accordance with the 2 A conditions of AATCC Test Method 61-2006.

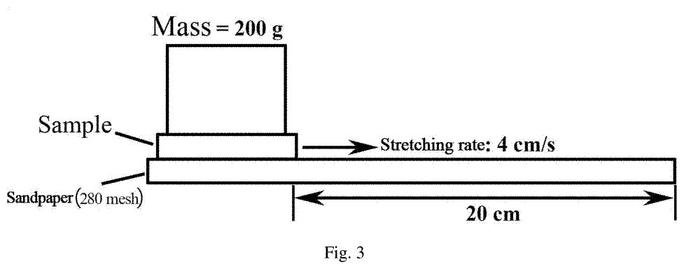

In order to evaluate the wear resistance of the super-hydrophobic fabric, the fabric was tested using a device as shown in FIG. 3. The wear test device consisted of a 280-mesh sandpaper and a weight of 200 g; the sandpaper was placed on a flat table and fixed; the fabric sample was placed on the sandpaper, and the weight of 200 g was placed on the fabric sample; the fabric sample was pulled 20 cm at a speed of 4 cm/s, which was regarded as 1 wear; after 600 wears, the contact angle of the fabric was measured.

Table 2 lists the water contact angle of the fabric after it had been worn for 600 times. It can be seen from Table 2 that the durable super-hydrophobic fabric prepared in this example could maintain the water contact angle of 150° or more even after 112 washes and 600 wears, indicating that it had excellent wash and wear resistance.

Referring to FIGS. 1 and 2, and Tables 1 and 2, the durable super-hydrophobic fabric prepared in this example had a contact angle of more than 150°. This is mainly due to the fact that the silicon dioxide formed by the hydrolysis of tetraethoxysilane was deposited under the action of the polydimethylsiloxane segment to form a micro-nano roughness structure and the hydrophobicity of the polydimethylsiloxane segment; and the superior chemical stability and mechanical durability of the super-hydrophobic fabric were mainly due to the fact that the hydroxyl groups of the silicon dioxide was further condensed with the hydroxyl groups of the polydimethylsiloxane to form a chemically crosslinked structure.

### Example 2

Soaking a cotton fabric into a mixed solution of tetraethoxysilane and polydimethylsiloxane having a molecular weight of 8000 in a mass ratio of 2:1; taking out the fabric and then placing it into a closed container filled with a hydrochloric acid solution (mass fraction: 10 wt %) and above the liquid level of the hydrochloric acid solution; placing the closed container in an oven and reacting for 2 h under the temperature of 30° C. to obtain the durable super-hydrophobic fabric.

Table 1 lists the contact angles of the durable super-hydrophobic fabrics of this example measured after they had been respectively soaked in acetone, ethanol, toluene and hexane for 168 h, and then washed and dried. Table 2 lists the water contact angles measured after the durable super-hydrophobic fabric of this example was washed 112 times in accordance with the 2 A conditions of AATCC Test Method 61-2006 and worn 600 times in accordance with FIG. 3 (vertical pressure: 2.5 kPa; stretching rate: 4 cm/s; stretching distance: 20 cm; and sandpaper: 280 mesh). It can be seen from Table 1 that the water contact angle of the durable super-hydrophobic fabric prepared in this example was maintained at 150° or more after the fabric had been soaked in different solvents for 168 h, indicating that the fabric had excellent chemical stability. It can be seen from Table 2 that the durable super-hydrophobic fabric prepared in this example could maintain the water contact angle of 150° or more even after 112 washes and 600 wears, indicating that it had excellent wash and wear resistance.

### Example 3

Soaking a nylon fabric into a mixed solution of tetraethoxysilane and polydimethylsiloxane having a molecular weight of 2000 in a mass ratio of 5:1; taking out the fabric and then placing it into a closed container filled with a hydrochloric acid solution (mass fraction: 15 wt %) and above the liquid level of the hydrochloric acid solution; placing the closed container in an oven and reacting for 1.5 h under the temperature of 45° C. to obtain the durable super-hydrophobic fabric.

Table 1 lists the contact angles of the durable super-hydrophobic fabrics of this example measured after they had been respectively soaked in acetone, ethanol, toluene and hexane for 168 h, and then washed and dried. Table 2 lists the water contact angles measured after the durable super-hydrophobic fabric of this example was washed 112 times in accordance with the 2 A conditions of AATCC Test Method 61-2006 and worn 600 times in accordance with FIG. 3 (vertical pressure: 2.5 kPa; stretching rate: 4 cm/s; stretching distance: 20 cm; and sandpaper: 280 mesh). It can be seen from Table 1 that the water contact angle of the durable super-hydrophobic fabric prepared in this example was maintained at 150° or more after the fabric had been soaked in different solvents for 168 h, indicating that the fabric had excellent chemical stability. It can be seen from Table 2 that the durable super-hydrophobic fabric prepared in this example could maintain the water contact angle of 150° or more even after 112 washes and 600 wears, indicating that it had excellent wash and wear resistance.

### Example 4

Soaking a acrylic fabric into a mixed solution of tetraethoxysilane and polydimethylsiloxane having a molecular weight of 5000 in a mass ratio of 4:1; taking out the fabric and then placing it into a closed container filled with a hydrochloric acid solution (mass fraction: 20 wt %) and above the liquid level of the hydrochloric acid solution; placing the closed container in an oven and reacting for 0.5 h under the temperature of 60° C. to give the durable super-hydrophobic fabric.

Table 1 shows the water contact angle of the durable super-hydrophobic fabric of the example of the invention after immersion in different solvents for 168 h. Table 1 lists the contact angles of the durable super-hydrophobic fabrics of this example measured after they had been respectively soaked in acetone, ethanol, toluene and hexane for 168 h, and then washed and dried. Table 2 lists the water contact angles measured after the durable super-hydrophobic fabric of this example was washed 112 times in accordance with the 2 A conditions of AATCC Test Method 61-2006 and worn 600 times in accordance with FIG. 3 (vertical pressure: 2.5 kPa; stretching rate: 4 cm/s; stretching distance: 20 cm; and sandpaper: 280 mesh). It can be seen from Table 1 that the water contact angle of the durable super-hydrophobic fabric prepared in this example was maintained at 150° or more after the fabric had been soaked in different solvents for 168 h, indicating that the fabric had excellent chemical stability. It can be seen from Table 2 that the durable super-hydrophobic fabric prepared in this example could maintain the water contact angle of 150° or more even after 112 washes and 600 wears, indicating that it had excellent wash and wear resistance

TABLE 1

Solvent

| Sample | Acetone | Ethanol | Toluene | Hexane |
|---|---|---|---|---|
| Example 1 | 158.5° | 158.0° | 156.5° | 154.0° |
| Example 2 | 156.0° | 155.5° | 157.0° | 155.0° |
| Example 3 | 154.5° | 156.5° | 154.5° | 153.0° |
| Example 4 | 155.0° | 153.0° | 155.5° | 154.5° |

Note:
The test was carried out using the DSA100 contact angle tester from KRUSS, Germany. An average value was taken from 5 points for each sample.

Table 2 lists the water contact angles measured after the durable super-hydrophobic fabric of this example of the invention was washed 112 times in accordance with the 2 A conditions of AATCC Test Method 61-2006 and worn 600 times in accordance with FIG. 3 (vertical pressure: 2.5 kPa; stretching rate: 4 cm/s; stretching distance: 20 cm; and sandpaper: 280 mesh).

TABLE 2

| | Wash resistance test | Wear resistance test |
|---|---|---|
| Sample | 112 times | 600 times |
| Example 1 | 155.0° | 155.5° |
| Example 2 | 153.5° | 152.0° |
| Example 3 | 151.0° | 154.0° |
| Example 4 | 152.5° | 155.0° |

Note:
The wash resistance test was carried out according to the 2A conditions of AATCC

Test Method 61-2006, and the wear test was carried out according to FIG. 3 (vertical pressure: 2.5 kPa; stretching rate: 4 cm/s; stretching distance: 20 cm; and sandpaper: 280 mesh). The water contact angle was measured using the DSA100 contact angle tester from KRUSS, Germany, and an average value was taken from 5 points for each sample.

1. A preparation method of a durable super-hydrophobic fabric, characterized in that: the preparation method comprises the following steps: soaking a fabric into a mixed solution of tetraethoxysilane and hydroxy-terminated polydimethylsiloxane; taking out the fabric and then placing it into a closed container filled with a hydrochloric acid solution and above the liquid level of the hydrochloric acid solution; reacting for 0.5-2 h under the temperature of 30-60 ° C. to obtain a durable super-hydrophobic fabric.

2. The preparation method of a durable super-hydrophobic fabric according to claim 1, characterized in that: the hydroxy-terminated polydimethylsiloxane has a molecular weight of from 400 to 8,000.

3. The preparation method of a durable super-hydrophobic fabric according to claim 1, characterized in that: the mass ratio of the tetraethoxysilane to the hydroxy-terminated polydimethylsiloxane is from 2:1 to 5:1.

4. The preparation method of a durable super-hydrophobic fabric according to claim 1, characterized in that: the mass percentage of the hydrochloric acid solution is 10-20 wt %.

5. The preparation method of a durable super-hydrophobic fabric according to claim 1, characterized in that: the reacting for 0.5-2 h under the temperature of 30-60° C. is carried out by placing the closed container in an oven at a controlled temperature of 30-60° C.

6. The preparation method of a durable super-hydrophobic fabric according to claim 1, characterized in that: the fabric is a fabric of any one of polyester, cotton, wool, nitrilon, polyurethane, and nylon.

7. A durable super-hydrophobic fabric, characterized in that: it is prepared by the method according to any of claims 1-6.

8. The durable super-hydrophobic fabric according to claim 7, characterized in that: the fabric has a contact angle of from 150° to 165°, and still remains super-hydrophobic after 168 h or more of organic solvent soaking, and 112 washes or 600 wears for testing.
